(19) United States
(12) Patent Application Publication
(10) Pub. No.: US 2015/0011298 A1
(43) Pub. Date: Jan. 8, 2015

(54) SYSTEM AND METHOD FOR CONDUCTING A FANTASY EVENT

(71) Applicant: Fantasy Sports RPG, LLC, Bay City, MI (US)

(72) Inventors: Michael J. Haid, Haslett, MI (US); Mark J. McKinley, Kawkawlin, MI (US)

(21) Appl. No.: 14/322,476

(22) Filed: Jul. 2, 2014

Related U.S. Application Data
(60) Provisional application No. 61/842,718, filed on Jul. 3, 2013.

(51) Int. Cl. A63F 13/00

(52) U.S. Cl. CPC A63F 13/00; A63F 2300/634
USPC 463/24

(57) ABSTRACT

A method of conducting a fantasy event. The method comprises acquiring information for one or more members of one or more fantasy teams participating in the fantasy event, automatically selecting one or more portions of audio, visual, and/or audio/visual content stored in an electronic memory device using the acquired information, and generating a playback program using the selected content that reenacts at least a portion of the fantasy event. Separately or in combination, the method comprises assigning a point enhancer to a member of a fantasy team in response to a user input, the enhancer serving to enhance the fantasy point total of that team member, acquiring information corresponding to the team member, and determining, based on the information and on the enhancer, a point total for the team member in accordance with a scoring scheme. Also provided is a system for implementing the method.

### CROSS-REFERENCE TO RELATED APPLICATION

This application claims the benefit of U.S. Provisional Ser. No. 61/842,718 filed on Jul. 3, 2013, the entire contents of which are hereby incorporated by reference.

### TECHNICAL FIELD

The present disclosure relates generally to systems and methods for conducting electronic games (e.g., computerized, online, internet-based, etc. games), and more particularly, to systems and methods for conducting fantasy events.

### BACKGROUND

The concept of fantasy sports is well known and fantasy sports events have been implemented in a variety of ways. In general terms, a fantasy sports event is a contest between two or more participants each having a team or roster of one or more team members comprised of actual players or competitors from a given sport or competition. For example, if the fantasy event is a fantasy football game, each participant may have a roster of actual or real football players (e.g., professional football players); if the fantasy event is a fantasy baseball game, each participant will have a roster of actual or real baseball players (e.g., professional baseball players); if the fantasy event is a fantasy motor sports game, each participant will have a roster of actual or real drivers; etc.

In most, if not all, conventional fantasy sports events, a participant's score is directly related to and dictated at least in part by the performance of some or all of the members of the participant's fantasy team during one or more real or actual competitions or sporting events in which those team members participate, and more particularly, performance-related information or data (e.g., statistics) corresponding to those team members. For example, in an instance where the fantasy event is a fantasy baseball game, a participant may score points when, for example: one or more pitchers on his/her roster strikes out an opposing player; one or more batters hits a single, double, triple, or home run; when a base runner steals a base or scores a run; etc. A participant may also have points deducted from his/her score when, for example: one or more batters strikes out; one or more pitchers gives up a home run or a walk; etc. In certain instances, performance-related information or data corresponding to each member of a participant's team or on a participant's roster is taken into account for purposes of scoring. In other instances, the participant may select or designate which team members on his/her team or roster are to be considered “playing” or in the participant's “lineup” in the fantasy sports event, and the information or data of those selected or designated team members is taken into account for purposes of scoring.

The fantasy sports event may be based on one or more actual or real competitions or sporting events taking place on a given day, or may be based on another period of time, such as, for example, a week, a month, or some other period of time. In an instance where the fantasy sports event corresponds to real competitions or games conducted or played on one particular day, a participant's roster/lineup may be comprised only of team members playing that day, or a participant may have to designate team members from his/her roster who are playing or competing that day to be in his/her team's lineup. This may be common where the fantasy sports event relates to a sport or competition where a team plays or a competitor competes more than once a week, for example, hockey, baseball, and basketball. In an instance where the fantasy sports event corresponds to real competitions or games conducted or played during a given week, a participant's roster may be comprised only of team members playing that week, or a participant may have to designate team members from his/her team or on his/her roster who are competing or playing to be in his/her team's lineup that week. This may be common where the fantasy sports event relates to a sport or competition where a team or a competitor plays or competes once a week, and the competition(s) or game(s) may be spread out over different days during that week, for example, football where a team plays once a week and may play on any number of days (e.g., Thursday, Saturday, Sunday, or Monday).

In any event, in an embodiment, once all of the team members whose performance-performance information is taken into account in a fantasy sports event have played their games or competed in their competitions, the points of the participants in the fantasy sports event generated by the performance-related information or data of the team members on the respective rosters/lineups are tallied and compared, and the participant with the most points is declared the winner.

While conventional fantasy sports events have been widely accepted by both sports enthusiasts and casual fans alike, they are not without their shortcomings. For example, many conventional fantasy sports events include only a minimal to moderate amount of skill on the part of the participants. More particularly, a participant's success may be more of a function of the particular team members of the participant's team or on the participant's roster than on the particular skill of the participant himself/herself as the participant may simply pick the best team members available to play or compete in the fantasy sports event. Additionally, conventional fantasy sports events may allow for relatively limited participant interaction, flexibility, and options in playing or participating in the fantasy sports event.

### SUMMARY

According to one embodiment of the invention, a method of conducting a fantasy event is provided. The method comprises: acquiring information for one or more members of one or more fantasy teams participating in the fantasy event; automatically selecting one or more portions of audio, visual, and/or audio/visual content stored in an electronic memory device using the acquired information, wherein the selected content may be used to reenact at least a portion of the fantasy event; and generating a playback program using the selected content that reenacts at least a portion of the fantasy event.

According to another embodiment of the invention, a system for conducting a fantasy event is provided. The system comprises an electronic processor and an electronic memory device electrically coupled to the electronic processor and having instructions stored therein, wherein the processor is configured to access the memory device and execute the instructions stored therein such that it is operable to: acquire information for one or more members of one or more fantasy teams participating in the fantasy event; automatically select one or more portions of audio, visual, and/or audio/visual content stored in an electronic memory device using the acquired information, wherein the selected content may be used to reenact at least a portion of the fantasy event; and generate a playback program using the selected content that reenacts at least a portion of the fantasy event.

According to a further embodiment of the invention, a method of conducting a fantasy event is provided. The method comprises: assigning a point enhancer to a particular member of a fantasy team in response to a user input, wherein the enhancer serves to enhance the fantasy point total of that particular team member; acquiring information corresponding to the particular team member to which the enhancer was assigned; and determining, based on the acquired information and on the assigned enhancer, a fantasy point total for the particular team member to which the enhancer was assigned in accordance with a predetermined scoring scheme.

According to yet another embodiment of the invention, a system for conducting a fantasy event is provided. The system comprises an electronic processor and an electronic memory device electrically coupled to the electronic processor and having instructions stored therein, wherein the processor is configured to access the memory device and execute the instructions stored therein such that it is operable to: assign a point enhancer to a particular member of a fantasy team in response to a user input, wherein the enhancer serves to enhance the fantasy point total of that particular team member; acquire information corresponding to the particular team member to which the enhancer was assigned; and determine, based on the acquired information and on the assignment enhancer, a fantasy point total for the particular team member to which the enhancer was assigned in accordance with a predetermined scoring scheme.

### BRIEF DESCRIPTION OF THE DRAWINGS

One or more embodiments of the invention will hereinafter be described in conjunction with the appended drawings, wherein like designations denote like elements, and wherein:

FIG. 1 is a diagrammatic and schematic view of an embodiment of a system configured to perform the methodologies described herein;

FIG. 2 is a flow chart depicting an embodiment of method for conducting a fantasy event; and

FIGS. 3-10 depict embodiments of various user interfaces that may be displayed on a user input device of the system illustrated in FIG. 1 and used in the implementation and/or performance of the methodologies described herein.

### DETAILED DESCRIPTION OF THE ILLUSTRATED EMBODIMENT(S)

The systems and methods described herein may be used to conduct any number of fantasy events relating to, for example, any form of competition or sporting event. For purposes of illustration and clarity, the description below may be with respect to fantasy events in the nature of fantasy sports events. It will be appreciated, however, that the present disclosure is not meant to be limited to any one particular fantasy event, and therefore, the methods and systems described herein may be used for fantasy events relating to competitions other than sports or sporting events, and thus, fantasy events other than fantasy sports events. Additionally, while the description below may be with respect to a particular type of fantasy sports event, for example, a fantasy sports game based on information and/or data corresponding to single performances of one or more team members of a fantasy team (e.g., for each team member, the information or data corresponds to one actual or real game or competition the team member took part in, for example, a single baseball game), and/or one or more particular sports, it will be appreciated that the present disclosure is not meant to be so limited. Rather, the methods and systems described herein may also be used for fantasy sports events that are based on information or data corresponding to one or more performances of one or more team members of fantasy team (e.g., for each team member, the information or data corresponds to: one or more real or actual games or competitions the team member took part in, for example, a baseball series, a playoff series, etc.; all real or actual games or competitions the team member takes part in over a particular period of time (e.g., days, weeks, months, years); etc.). Similarly, the methods and systems described herein may be used for fantasy sports events involving any number of sports, including, for example and without limitation, baseball, football, basketball, hockey, motor sports, track and field, Olympic competitions, soccer, horse racing, tennis, and golf, to cite only a few possibilities. Thus, it will be appreciated by those of ordinary skill in the art that the present disclosure is not limited to any particular type or category of fantasy event.

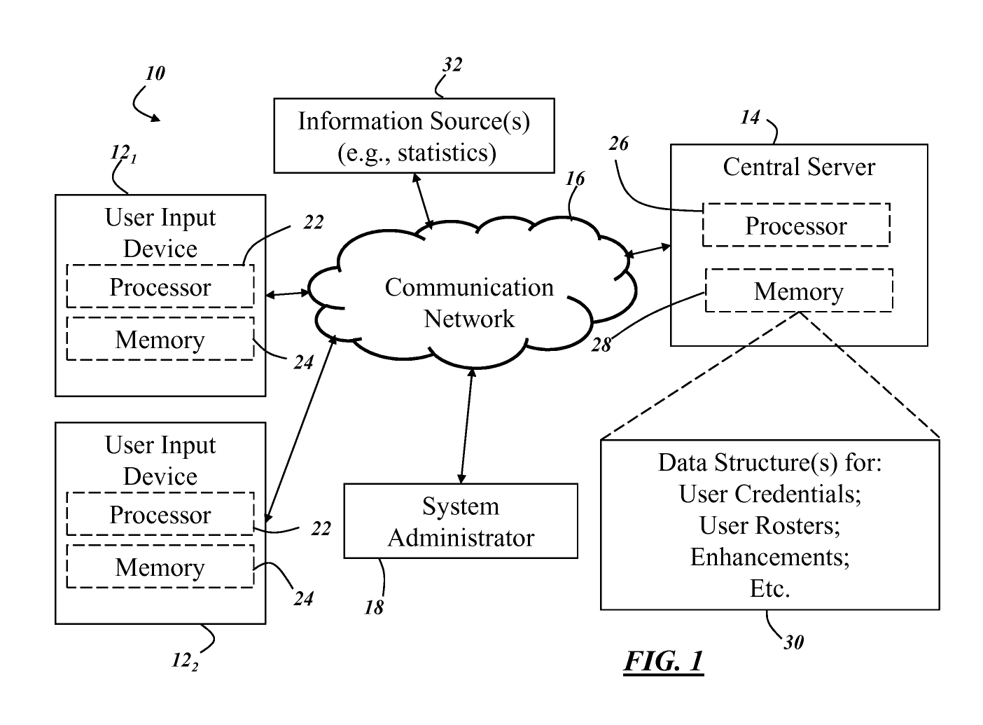

Referring now to the drawings, FIG. 1 illustrates an illustrative embodiment of a system 10 for conducting a fantasy sports game. In its most general or simple form, the system 10 may comprise one or more user input devices 12, a central server 14, and a communication network 16 configured to facilitate communication between, for example, the user input device(s) 12, the central server 14, and, in certain embodiments, other components that may or may not be part of the system 10. In an embodiment, the system may further comprise a system administrator 18 that may be configured to interface with, for example, the central server 14 and exert a measure of control over the system 10 and the functions and processes performed thereby. The system administrator 18 may be configured to communicate with the central server 14 through, for example, a web portal or using any other means known in the art.

The system 10 may include one or multiple user input devices 12 (e.g., interfaces 12₁, 12₂). While the particular number of user input devices 12 supported by the system 10 may be unlimited, for purposes of illustration and clarity, the description below will be with respect to an embodiment such as that illustrated in FIG. 1 wherein the system 10 is configured for a fantasy sports game between two participants, and thus, comprises a pair of user input devices 12—a first user input device 12₁ for a first participant and a second user input device 12₂ for a second participant. It will be appreciated, however, that the present disclosure is not meant to be so limited and that in other embodiments, the system 10 may include a single user input device 12 (i.e., all participants use the same input device), or more than two user input devices 12. In such embodiments, the description of the user input device(s) 12 provided herein may apply with equal weight to each such user input device 12.

Each user input device 12 may be electronically connected to (e.g., hardwired or wirelessly), and configured for communication with, the central server 14, and may include any number of devices suitable to display or provide information to and/or to receive information from a user. As such, each user input device 12 may comprise any combination of hardware, software, and/or other components that enable a user to communicate or exchange information with, for example, the central server 14. More particularly, in an embodiment, each user input device 12 may comprise one or a combination of any number of known user input devices, such as, for example: a liquid crystal display (LCD); a touch screen LCD (e.g., a 15-inch touch screen LCD); a cathode ray tube (CRT); a plasma display; a keypad; a keyboard; a computer mouse or roller ball; a joystick; a microphone; a speaker; a handheld device (e.g., telephone, smart phone, tablet, personal digital assistant (PDA), etc.); one or more switches or buttons; or any other display or monitor device. As such, it will be appreciated that the present disclosure is not limited to any specific input device(s) or combination(s) of input devices.

As will be appreciated by those having ordinary skill in the art, each user input device 12 may further include an electronic processor or processing device 22 and an electronic memory device 24. The processor 22 may include any type of suitable electronic processor (e.g., programmable microprocessor, microcontroller, an application specific integrated circuit (ASIC), etc.) that is configured to process data and/or execute appropriate programming instructions for software, firmware, programs, applications, algorithms, scripts, etc., to perform various functions, such as, for example, those described herein. The memory device 24 may include any type of suitable electronic memory means and may store a variety of data and information. This includes, for example, software (e.g., code or logic), firmware, programs, applications, algorithms, scripts, and other instructions that, for example, are required to perform one or more of the functions described herein.

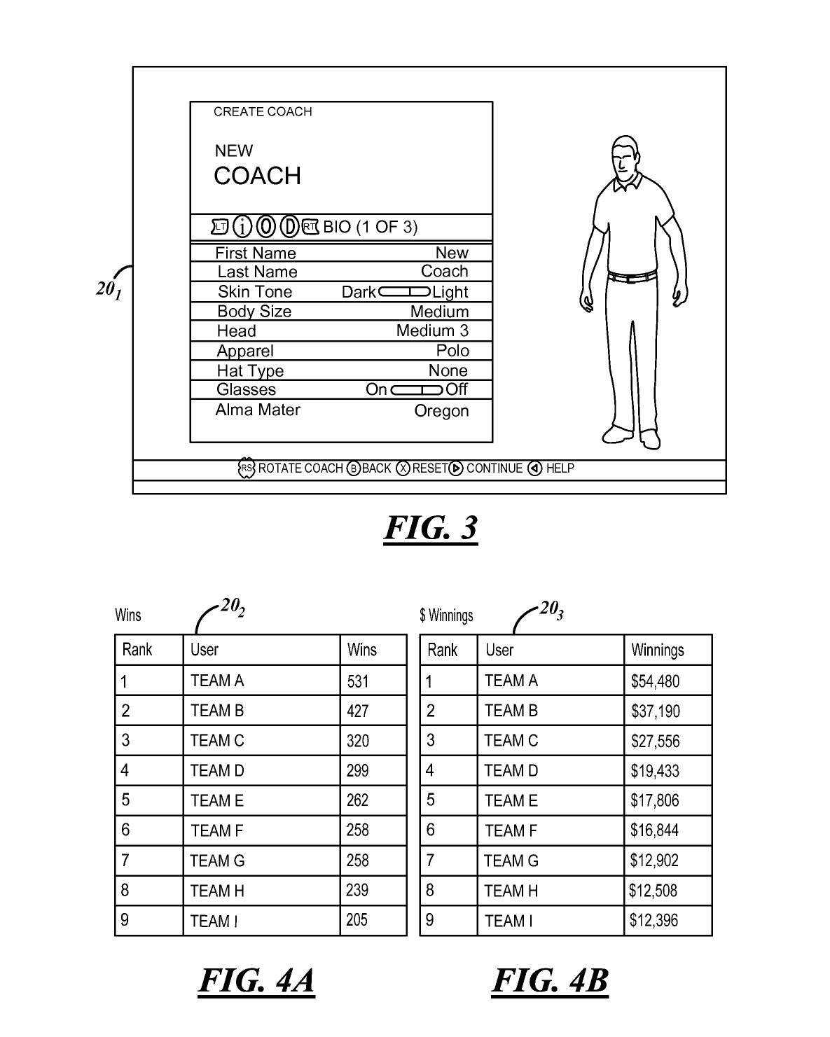

In addition to the above, in an embodiment, each of the user input devices 12 may include one or more user interfaces, such as a graphical user interface (GUI) and/or a text-based user interface, or may be configured to generate and/or display one or more user interfaces that may be used in conjunction with one or more of the user input devices identified above (e.g., a text based user interface may be displayed on an LCD screen of a user input device and a keyboard thereof may be used in conjunction with the user interface, a GUI may be displayed on a LCD of a user input device and a mouse thereof may be used in conjunction with the user interface, etc.). Various examples of user interfaces (i.e., user interfaces 20) are depicted in FIGS. 3-10. In an embodiment, one or more components of the system 10 (e.g., the central server 14, a software application (hereinafter to referred to as an “app”) stored on a user input device 12 (e.g., on memory 24 thereof) or elsewhere in the system 10, etc.) may be configured to generate one or more user interfaces 20 in the form of a graphical and/or text-based interface having one or more user-selectable or user-inputtable fields, icons, links, etc. that may be displayed on a suitable device (e.g., the user input devices 12 or component thereof or used therewith, such as, for example, a display device) and allow a user to interact or communicate with the central server 14 via text, voice, or graphical interfaces, to name a few. It will be appreciated that in an embodiment wherein the user interface(s) 20 is/are communicated to a user input device 12 from, for example, the central server 14, it may be done so across the communication network 16 using any number of well known communication techniques and protocols, such as, for example, one or more of those described below.

In any event, in an embodiment, each user input device 12 may be operable to provide an interactive interface that allows a user to interact with other components of the system 10, for example, the central server 14, for the purposes described below. For instance, a user input device 12 may be configured to display a message prompting a user to log into the system 10 by providing certain credentials, or to make certain selections relating to the fantasy sports game in which the user wishes to take part. The user input device 12 may also provide a means by which such credentials, information, and/or selections may be inputted or provided (e.g., user-selectable or user-inputtable fields, icons, links, menus, etc.). The input provided by the user via the user input device 12 may then be communicated to the central server 14, which may take certain action(s) in response to the received input(s).

The central server 14, which may be a standalone component or a part of either another component of the system 10 or a larger network or system of which the system 10 is a part, may be used to control, govern, or otherwise manage certain operations or functions of the system 10. The central server 14 may be implemented with a combination of hardware, software, firmware, and/or middleware, and according to an embodiment such as that illustrated in FIG. 1, may include one or more electronic processors or processing devices 26 and one or more electronic memory devices 28. In one embodiment, the memory device 28 is a component of the processor 26; while in another exemplary embodiment, the memory device 28 is separate and distinct from the processor 26 but accessible thereby.

The processor 26 may include any type of suitable electronic processor (e.g., a programmable microprocessor or microcontroller, an electronic control unit, a central processing unit (CPU), an application specific integrated circuit (ASIC), etc.) that executes instructions for software, firmware, programs, algorithms, scripts, etc. The processor 26 may further include an input/output (I/O) interface through which it may receive and transmit input and output signals, such as, for example, those communicated between the user input device(s) 12 and the central server 14, or between the central server 14 and other components that may or may not be part of the system 10, including, but not limited to, those described below.

The memory device 28 may include any type of suitable electronic memory means and may store a variety of information and data. This includes, for example and without limitation: one or more data structures 30 containing information/data including that described below (e.g., user log in credentials, fantasy sports teams/rosters, scoring schemes, etc.); software; firmware; programs; algorithms; scripts and other electronic instructions; etc. In an embodiment, the electronic instructions and/or other information (e.g., data structures) needed for performing or carrying out all or a portion of the methods described herein may be stored or otherwise maintained in the memory device 28. Alternatively, those instructions and/or information may be stored in a different memory device that is accessible by the processor 26 or another device configured to perform some or all of the functionality described herein.

As briefly described above, and as will be described in greater detail below, the central server 14 is configured communicate with one or more user input devices 12, as well as, in certain embodiments, other components that are part of the system 10 or otherwise (e.g., system administrator 18, third party information sources 32 (best shown in FIG. 1), etc.). It will be appreciated by those having ordinary skill in the art that such communication may be across the communication network 16 and may be supported or facilitated by any number of well known communication techniques and protocols. To that end, the central server 14 and the user input device(s) 12 may each include, or be electronically connected to and configured for communication with, certain communication-supporting infrastructure (e.g., one or more known components or devices, such as, for example, routers, modems, antenna, electrical ports, transceivers, etc.) that is/are configured to allow for the communication and exchange of information/data between various components of the system 10 via, for example, a public or private network (e.g., the internet) or using other suitable communication techniques or protocols including, but not limited to, one or more of those described elsewhere below.

The communication network 16 may comprise a wired or wireless network, such as, for example: suitable Ethernet networks; radio and telecommunications/telephony networks, such as, for example, cellular networks, analog voice networks, or digital fiber communications networks; storage area networks, such as, for example, Fibre Channel SANs; or any other suitable types of networks and/or protocols (e.g., local area networks (LANs); wireless local area networks (WLANs); broadband wireless access (BWA) networks; personal area networks (PANs), such as, for example, Bluetooth; etc.). The communication network 16 may be configured for use with one or more standard communications technologies and protocols, and may utilize links using technologies such as, for example, Ethernet, IEEE 802.11, integrated services digital network (ISDN), digital subscriber line (DSL), and asynchronous transfer mode (ATM), as well as other known communications technologies. Similarly, the networking protocols used on the communication network 16 may include multi-protocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP), among other network protocols. The data exchanged over the communication network 16 may be represented using technologies, languages, and/or formats, such as the hypertext markup language (HTML), the extensible markup language (XML), and the simple object access protocol (SOAP) among other data representation technologies. Additionally, all or some of the links or data may be encrypted using any suitable encryption technologies, such as, for example, the secure sockets layer (SSL), Secure HTTP and/or virtual private networks (VPNs), the international data encryption standard (DES or IDEA), triple DES, Blowfish, RC2, RC4, R5, RC6, as well as other known data encryption standards and protocols. In other embodiments, custom and/or dedicated data communications, representation, and encryption technologies and/or protocols may be used instead of, or in addition to, the particular ones described above. Further, it will be appreciated that in an embodiment, the central server 14, the user input device(s) 12, and potentially other components of the system 10 may each be configured to communicate with each other using more than one communication technique or protocol as a fail-safe so as to provide redundancy and flexibility in the event a given technique or protocol is rendered unusable for any reason, or different components communicate using different protocols or techniques.

It will be further appreciated that depending on the particular implementation of the system 10, the distance from a user input device 12 to the central server 14, or from one of these components to another component with which it communicates, may range from a matter of feet to an unlimited number of miles. Accordingly, the particular communication techniques and protocols used may depend in large part on the relative distance between the devices or components that are communicating with each other, as well as on the availability of certain infrastructure required for the various techniques/protocols (e.g., cellular reception, existence of PSTN lines, etc.).

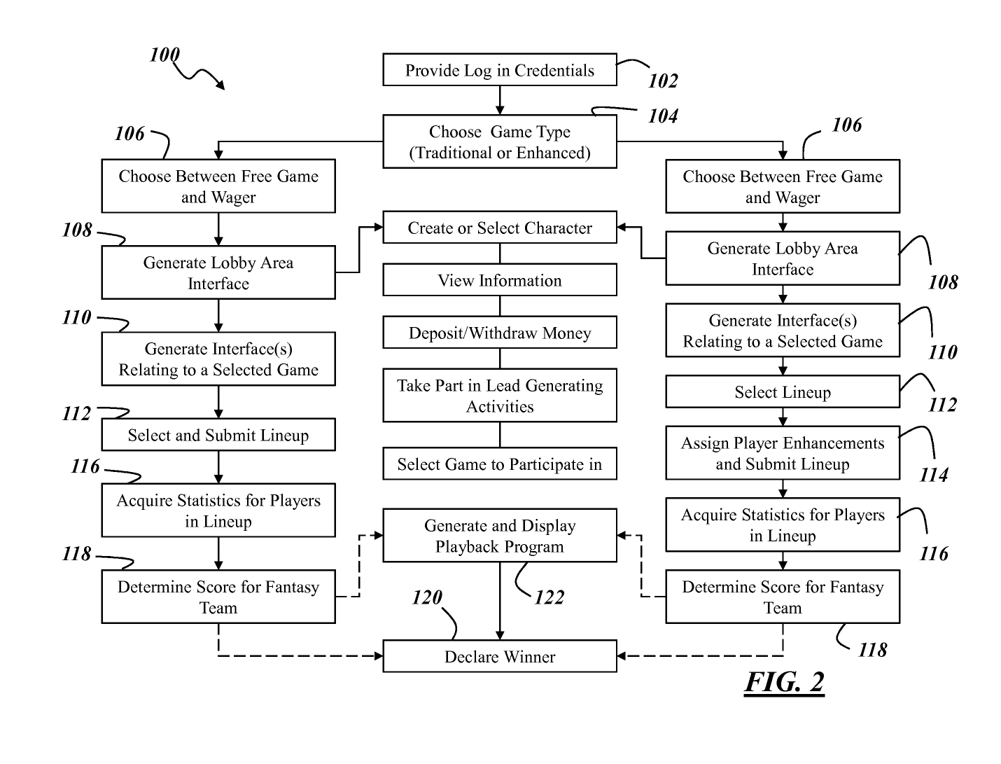

Turning now to FIG. 2, there is shown an example of a method 100 for conducting a fantasy event. For purposes of illustration and clarity, method 100 will be described in the context of a fantasy event in the nature of a fantasy sports game, and in the context of the system 10 described above. It will be appreciated, however, that the application of the present methodology is not meant to be limited solely to such a fantasy event or such an arrangement of a system for performing or implementing the methodology. Rather, method 100 may find application with any number of fantasy events (i.e., other than fantasy sports) or system arrangements (i.e., the steps of method 100 may be performed by components or devices of the system 10 other than those described below, or system arrangements other than that described above). Additionally, unless otherwise noted, the performance of method 100 is not meant to be limited to any particular order or sequence of steps or to any particular components for performing the steps.

In an embodiment, method 100 comprises a first step 102 of prompting a user (also referred to as a “participant”) to log into the system 10. This may entail, for example and as illustrated in FIG. 2, prompting the user to enter certain predetermined credentials associated with the user (e.g., user name and password, age, etc.) to allow the system 10 to verify that the user is permitted or authorized to log into the system 10. In an embodiment, the central server 14 of the system 10 is configured to generate a log in interface or screen that may be displayed on the particular user input device 12 the user is utilizing, and may do so, for example, in response to the accessing of a website through a web browser (e.g., a website hosted on the central server 14), upon the launching of a software application (or app) stored locally on the user input device 12, or in any other way known in the art. The interface may include one or more user-inputtable or user-selectable fields (e.g., text boxes, drop down menus, etc.) that the user may utilize to input his/her login credentials. In an embodiment, the user's credentials may be communicated from the user input device 12 to the central server 14 in the form of one or more electrical signals representative of the credential information, and the central service 14 may be configured to process the information to determine if the user is authorized to access the system 10 using any number of techniques known in the art. For instance, in one embodiment provided for illustrative purposes only, the processor 26 of the central server 14 may be configured to compare the provided credentials to information stored in a data structure of the memory device 28 of the central server 14 and to determine that the user is authorized only when there is a match between the provided credentials and those stored in the memory device 28. Alternatively, rather than communicating the user-provided credentials to the central server 14 at this point, the credentials may be processed and acted upon locally on the user input device 12 through an app stored thereon.

Once a user has successfully logged in, method 100 may include the step 104 of selecting the particular fantasy sport of interest (e.g., basketball, baseball, hockey, etc.) and/or, as illustrated in FIG. 2, the particular type of fantasy game in which the user wishes to participate. In an embodiment, selecting a type of game may comprise selecting between a “traditional” fantasy game and an “enhanced” fantasy game. Except as described elsewhere herein, a traditional fantasy game is closely akin to conventional fantasy games including those described elsewhere above. Alternatively, and as will be described in greater detail below, an enhanced fantasy game is one in which enhancements (or enhancers) or upgrades may be applied to or associated with one or more team members of a fantasy sports team, or on or in a roster/lineup of a fantasy team, so that points generated by information and/or data (e.g., game/competition statistics) corresponding to that or those team members are enhanced. In certain embodiments, many features or aspects are common to both the traditional and enhanced types of games. Accordingly, unless specified otherwise, the description below applies to the traditional and enhanced type of fantasy games alike.

In an embodiment, the central server 14 of the system 10 is configured to generate an interface or screen that may be displayed on the user input device 12 the user is utilizing from which the user may make his/her selection in step 104. Alternatively, the interface may be generated by an app stored on the user input device 12. In either instance, the interface may include one or more user-inputtable or user-selectable fields (e.g., text boxes, drop down menus, radio buttons, check boxes, etc.) that the user may use to select the type of game s/he wishes to play. Once entered, the user's selection may be communicated from the user input device 12 to the central server 14 in the form of one or more electrical signals representative of the user's selection, and central server 14 may be configured to process and act upon the selection accordingly. Alternatively, rather than communicating the user's selection to the central server 14 at this point, the selection may be processed and acted upon locally on the user input device 12 through an app stored thereon. In an embodiment wherein only one type of fantasy game is supported or available—i.e., either traditional or enhanced—step 104 would not be necessary, and therefore, may be optional.

Once the particular type of fantasy game has been established either by default or in response to a user's selection in step 104, in one embodiment, method 100 may further include a step 106 of prompting the user to indicate whether he/she wants to place a wager (e.g., entry fee or rake) on the fantasy game or play a “free game” where no wagers are required. The user may be prompted for this information at the same time or after he/she is prompted to log into the system 10 (step 102) or to make a selection as to the type of fantasy game (i.e., traditional or enhanced) (step 104) using the same interface; alternatively a separate interface may be displayed from which the user may make his/her selection in step 106. In any instance, in an embodiment, the central server 14 of the system 10 may be configured to generate an interface or screen that may be displayed on the user input device 12 the user is utilizing from which the user may make his/her selection. Alternatively, the interface may be generated by an app stored on the user input device 12. In either instance, the interface may include one or more user-inputtable or user-selectable fields (e.g., text boxes, drop down menus, radio buttons, check boxes, etc.) that the user may use to indicate whether or not s/he wants to place a wager. Once entered, the user's selection may be communicated from the user input device 12 to the central server 14 in the form of one or more electrical signals representative of the user's selection, and the central server 14 may be configured to process and act upon the selection accordingly. Alternatively, rather than communicating the user's selection to the central server 14 at this point, the selection may be processed and acted upon locally on the user input device 12 through an app stored thereon. In an embodiment wherein the system 10 does not support both “free games” and wagering (e.g., where only free games are supported), step 106 may not be necessary, and therefore, may be optional.

Following the establishment of the type of game and whether or not the user wishes to place a wager, method 100 may further comprise a step 108 of generating one or more user interfaces that provide(s) the user with various types of information and/or that allow(s) the user to interact with the system 10 to, for example, make selections relating to the particular game the user wishes to play and/or to take other actions, and displaying that or those interfaces on the user input device 12. In an instance wherein the user interface(s) allow the user to interact with the system 10 to make selections or take other actions, step 108 may also comprise receiving electrical signal(s) representative of user inputs provided via the user interfaces, and acting upon the inputs in an appropriate manner. In any event, in an embodiment, the central server 14 of the system 10 is configured to generate such user interface(s), while in another embodiment, some or all of the interface(s) may be generated by an app stored on the user input device 12 itself. In either instance, one or more of the interfaces generated in step 108 may be referred to as a “lobby area” that serves as a central location from which a user may manage his/her fantasy sports game experience.

For example, in an embodiment and using an interface generated in step 108, the user may create an avatar or custom character to represent the user during a fantasy sports game. More particularly, in one embodiment, though certainly not the only embodiment, the user may be prompted to create a character or select an icon or a link displayed on the user interface (e.g., lobby area) resulting in the generation and display of another user interface that may be used to create a character. One example of such an interface is interface 20₁ illustrated in FIG. 3. Using this interface, the user may create a character to the user's liking by selecting various attributes, physical or otherwise, that the character may embody, including, for example and without limitation, one or more of: a name; skin tone; body size; head size; the type of apparel the character wears; the type of hat the character wears; whether the character wears eye or sunglasses; the alma mater of the character; etc. Some of the features/attributes from which the user may select in creating his/her character may be standard or free features meaning that they are always available and are available at no cost to the user. Other of the features/attributes may be premium attributes that the user may purchase using, for example, real currency (e.g., a credit card, money from an established account that is pre-loaded by the user or that contains the user's past accumulated winnings or money otherwise earned in a manner such as that or those described below, etc.) or virtual currency (e.g., points from an established account that were accumulated from past performances or otherwise earned in a manner such as that or those described below and that may or may not have monetary value). These premium items may be purchased from the same interface used to create the character, or alternatively, the user may select a link or icon that redirects the displayed page to a different interface (i.e., a store or auction house screen) from which the user may “purchase” desired items. In any event, in an embodiment, once the character creation process has been completed, the user may save the character and it may then be associated with the user and stored in, for example, a memory of accessible by of the central server 14 (e.g., it may be communicated to the central server 14 and stored in or on, for example, the memory device 28 thereof), on the user input device 12 (e.g., in or on the memory device 24 thereof), or both.

In another embodiment, rather than creating a character each time the user logs into the system 10, the user may be able to select a previously created character to represent him/her during the fantasy game, or a previously-created character may be automatically associated with the user by default, which may then be changed by revising the default character, selecting a different previously-created character (as described below), or creating an altogether new character (as described above). In an embodiment wherein the user wishes to select a character from one or more previously-created characters, one or more such characters may be associated with the user and stored in, for example, the memory device 28 of the central server 14 or locally at the user input device 12. The user may select the character he/she desires from a list of characters displayed on a user interface, using, for example, a drop down menu, radio buttons, check boxes, text boxes, etc.

Whether a new character is created or a previously-created one is selected, the interface(s) used to do so may be generated by the central server 14 of the system 10 and then displayed on the user input device 12 the user is utilizing. Alternatively, the interface(s) may be generated by an app stored on the user input device 12. User input provided via this interface may then be communicated to the central server 14 where it may be processed and acted upon accordingly, or may be processed and acted upon locally at the user input device 12, and/or communicated to the central server 14 at a later time.

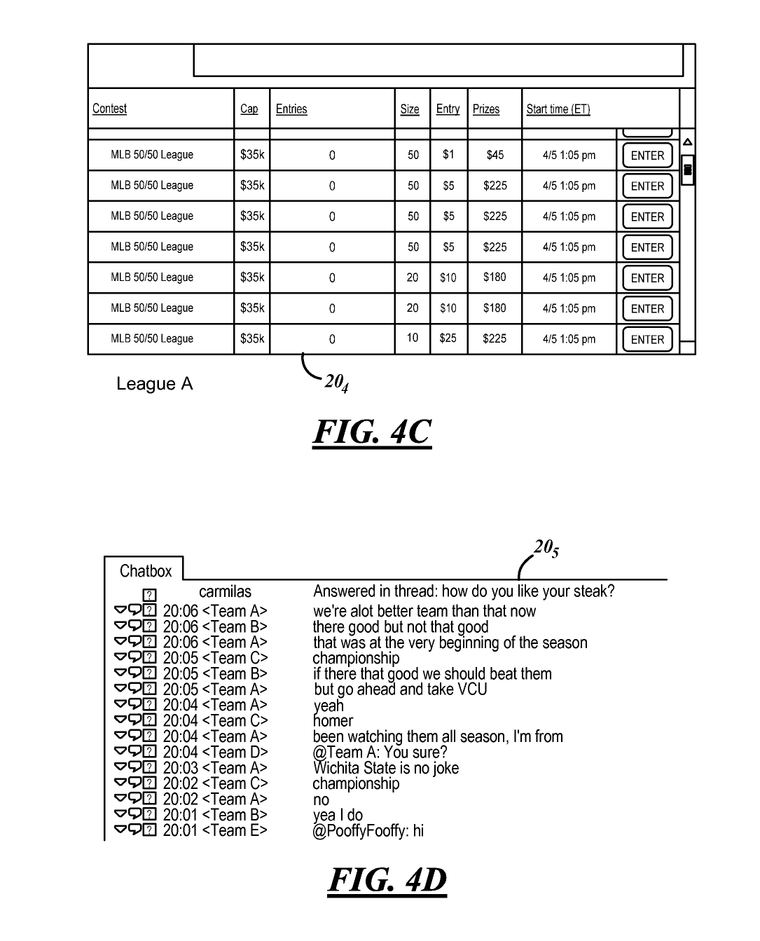

In addition to, or instead of, creating a custom character, additional information may be obtained and/or actions may be taken from the interface(s) generated in step 108. For example, and with reference to FIGS. 4A-4D, a user may be able to: view current standings or rankings of the league(s) s/he participates in or otherwise via a user interface such as interface 20₂ illustrated in FIG. 4A; view rankings of winnings earned (if applicable) within a league or otherwise via a user interface such as interface 20₃ illustrated in FIG. 4B; choose the particular fantasy game s/he wishes to take part in (which may be based, in part, on the associated entry fee, number of entries, the respective prize(s), etc.) via a user interface such as interface 20₄ illustrated in FIG. 4C; and/or chat with other users that may be in a league with the user or otherwise via a user interface such as interface 20₅ illustrated in FIG. 4D, to cite a few possibilities. Additionally, and not shown in FIG. 4, the user may buy or trade team members and/or get tips, training, and strategies for how to play particular games. This may be done either directly on a lobby area interface generated in step 108 or through another interface that may be accessed through the lobby interface and that may be generated and displayed in the same manner as those interfaces 20 described above.

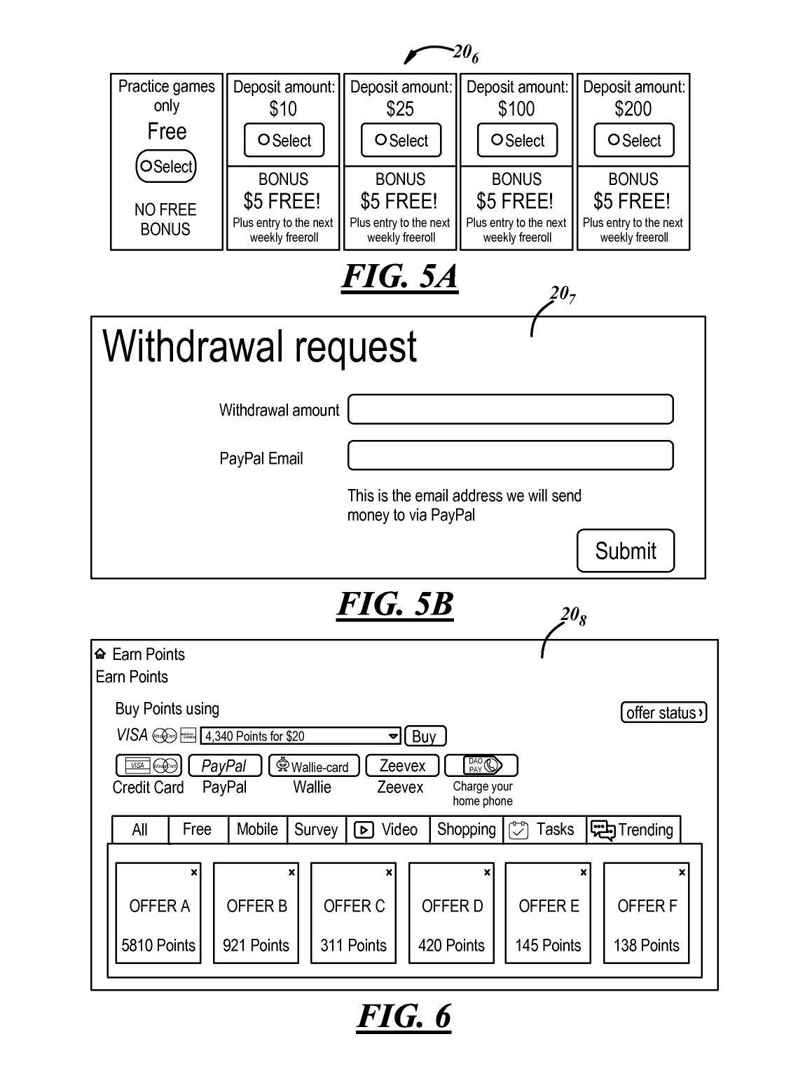

In certain embodiments, the user may further be able to conduct financial-related activities or transactions using one or more interfaces generated in step 108. For example, the user may be able to deposit money into a pre-established account via, for example, a credit card, electronic funds transfer, or any another suitable technique, utilizing a user interface such as, for example, interface 20₆ illustrated in FIG. 5A. The user's account may be used, for example, to pay entry fees to games (e.g., to place wagers), to purchase premium items for the user's character, etc. The user may also be able to withdraw money (e.g., winnings or money otherwise earned) from his/her pre-established account (e.g., by requesting a check, by redeeming winnings in the form of gift cards or other forms of redemption, etc.) via a user interface such as interface 20₇ illustrated in FIG. 5B. In an embodiment, a user may also be able to earn real or “virtual” currency (e.g., “points”) by taking part in lead-generating activities that may be selected from a user interface such as interface 20₈ illustrated in FIG. 6. More particularly, and as illustrated in FIG. 6, these activities may include, for example, participating in surveys, signing up for newsletters or becoming a member of an organization, watching videos relating to particular goods/services, taking advantage of certain advertised offers, etc. Any currency earned by taking part in these activities may be, for example, deposited into the user's account. In any event, in an embodiment, one or more of the depositing of money, withdrawing of money, and earning money/points from lead generating activities may be facilitated directly on a lobby area interface generated in step 108 or through another interface that may be accessed through the lobby area interface and that may be generated and displayed in the same manner as those interfaces 20 described above.

It will be appreciated in view of the foregoing that step 108 of method 100 may comprise the generation of any number of user interfaces that may be used to provide the user with various types of information and/or allow the user to take various types of actions. It will therefore be further appreciated that the present disclosure is not limited to any particular information or actions that may be provided or allowed to be taken, respectively, via user interfaces generated in step 108. Additionally, because of the variety of information that may be provided and actions that may be allowed to be taken, it will also be appreciated that step 108 may comprise generating a single interface from which all of the information to be provided to the user may be provided, and from which all actions that a user may be able to take may be taken, or alternatively, step 108 may comprise generating a plurality of interfaces, each of which provides certain information or allows certain actions to be taken. Accordingly, the present disclosure is not limited to any particular implementation of step 108. Further, and as briefly described above, the interface(s) generated in step 108 may be generated by the central server 14 of the system 10 and then displayed on the user input device 12 the user is utilizing, may be generated by an app stored on the user input device 12, or a combination of both. User inputs provided via the interfaces generated in step 108 and displayed on the user input device 12 associated with the user, may be communicated to the central server 14 in the form of one or more electrical signals, and the central server 14 may be configured to process and act upon the inputs accordingly. Alternatively, some or all of the inputs may be processed and acted upon locally at the user input device 12.

In response to the selection of a game that the user wishes to particular in (via, for example, a user interface generated in step 108) and, if applicable, the entry fee or wager (if applicable) being taken from the user's account or otherwise paid through, for example, a payment service (e.g., PayPal), a credit card, etc., method 100 may include a step 110 of generating and displaying on the user input device 12 one or more user interfaces that correspond to the particular game the user selected. These interface(s) may provide the user with various types of information about the selected game (e.g., rules, scoring information, number of team members a fantasy team may have and/or that may take part in the fantasy game, the required positions that have to be used, etc.), allow the user to interact with the system 10 (e.g., to select team members for the user's team or to set a lineup from an existing roster), and the like. As with the interfaces described above, in an embodiment, the central server 14 of the system 10 may be configured to generate the appropriate user interface(s), while in another embodiment some or all of the interface(s) may be generated by an app stored on the user input device 12 itself.

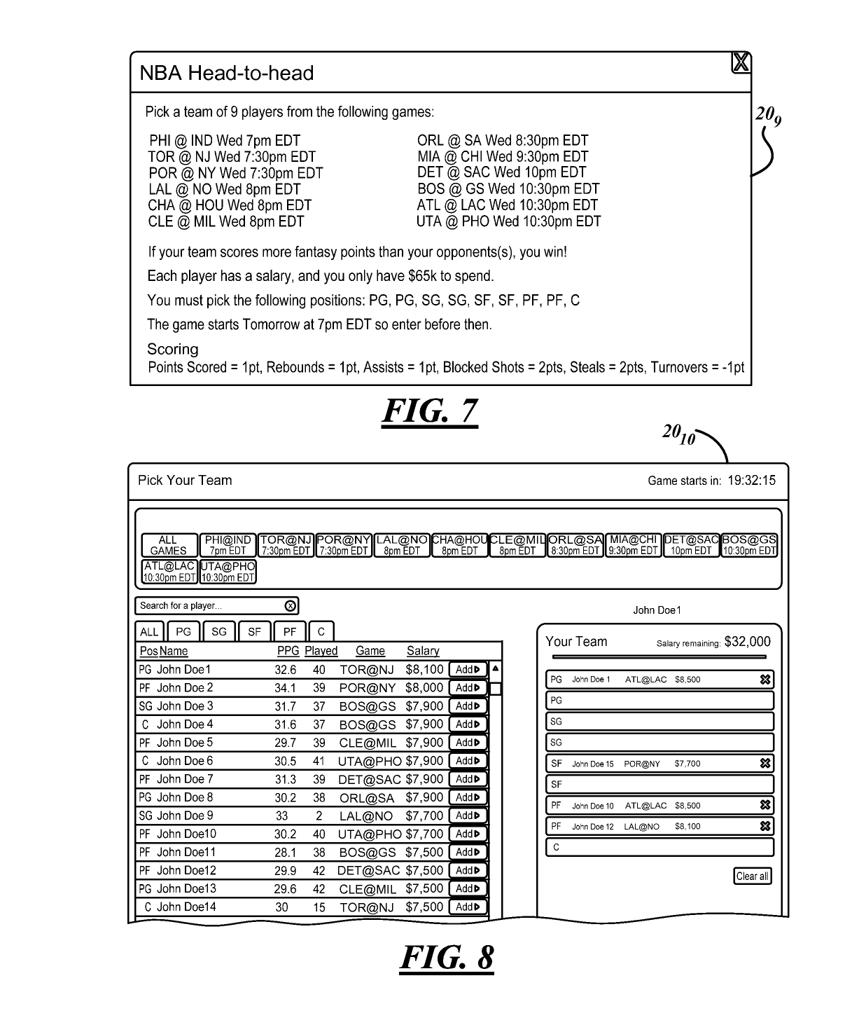

More particularly, and for purposes of illustration only, FIG. 7 depicts an illustrative user interface 20₉ for a particular fantasy basketball game referred to as “NBA Head-to-Head.” The interface 20₉ contains information relating to the game, including, for example, the NBA games from which a user may select members for their fantasy team, the salary limit for the game (i.e., a salary is attributed to each team member and the total salary of a team is capped at the salary limit, which, in this example, is $65,000), the particular positions that must be filled (e.g., one center and two point guards, shooting guards, small forwards, and power forwards), the point scheme used, etc.

FIG. 8 depicts another user interface, interface 20₁₀, that may be generated in step 110 and that, for purposes of illustration, also relates to the NBA Head-to-Head fantasy basketball game. In an embodiment, method 100 may comprise a step 112 of selecting a lineup to be used in the fantasy game, and, in such an embodiment, the interface 20₁₀ depicted in FIG. 8 may be utilized to select the lineup in step 112. More particularly, the interface 20₁₀ depicted in FIG. 8 is configured to allow the user to select team members for his team from among available players. In this embodiment, the user may view each NBA game from which s/he may select players to be members of his/her fantasy team, or view all of the available players. For each player, the players position and corresponding statistics may be displayed along with the game the player is playing in and the salary associated with the player—all of which may be taken into consideration by a user when selecting his/her team. This information may be stored on the central server 14, for example, or may be acquired by the central server 14 or user input device 12 from another component of the system or an external source, for example, a third party information source 32. As the user makes his selections by, for example, clicking or otherwise selecting a player's name, the fields representing his/her team are populated, as illustrated in FIG. 8. In another embodiment, rather than selecting new team members each time the user participates in a game, he/she may select or designate the appropriate number of team members from a preset roster containing the team members the user may have drafted or otherwise acquired via, for example, purchase, trade, free agency, etc. In such an embodiment, the user's preset roster may be associated with the user and stored in, for example, a memory device of or accessible by the central server 14 (e.g., memory 28) and may be retrieved and communicated to the user input device 12 by the processor 26 of the central server 14. In certain instances, the same player may be selected by more than one participant in the game such that one player may be a member of multiple fantasy teams, while in other embodiments a player may only be a member of one fantasy team/roster/lineup in a particular fantasy game. In any event, the user's selection(s) made in step 112 may be communicated to, for example, the central server 14 in the form of one or more electrical signal(s) representative of the selections made. That or those signals may then be processed by, for example, central server 14 (e.g., processor 26 thereof) and acted upon accordingly. Alternatively, some or all of the user's selections may be processed and acted upon locally at the user input device 12.

In an embodiment wherein the fantasy game is of the “enhanced” type as opposed to the “traditional” type, in addition to selecting or designating team members for a user's roster or lineup in step 112, the user may be given the opportunity to associate or assign enhancements or point enhancers to one or more team members on or in the user's roster or lineup. Accordingly, in an embodiment, the method may further comprise a step 114 of assigning one more point enhancers to one or more team members on a user's team or roster, or in a user's lineup.

More specifically, a user may have one or more enhancements or enhancers at his/her disposal that may be used to upgrade or enhance one or more members on his/her fantasy team or roster or in his/her lineup to enhance or modify the points generated by information or data corresponding to that or those team members. In an embodiment and as will be described below, depending on the game or competition performance of the team member with which an enhancer is associated, the point enhancers may be positive enhancements only or, alternatively, may be both positive and negative enhancements (i.e., the enhancers may add points to a user's score and, in at least certain embodiments, may also subtract points from a user's score depending on the associated team member's performance). The enhancements may apply to specific events or occurrences (e.g., home runs, strike outs, stolen bases), or may apply to the team member's overall point total. In an embodiment, each enhancer may be assigned to any team member on the roster or in the lineup independent of position or player type. In another embodiment, however, the team members with which a particular enhancer may be assigned or associated may be limited by attributes of the team member. For example, certain enhancers may only be available for team members who play certain positions (e.g., certain enhancers may only be applied to pitchers (in the context of baseball), kickers or quarterbacks (in the context of football), goalies (in the context of hockey), etc.). In addition, or alternatively, certain enhancers may be available for certain types of players (e.g., certain enhancers may only be applied to team members considered to be power hitters or base stealers (in the context of baseball). Further, the enhancer may have an indefinite life (e.g., may be used for an entire game or in all games), or may be limited in terms of number of uses (e.g., an enhancer may be used for a certain number of at-bats, for a certain number of games, etc.).

In an embodiment, each enhancer may have a value associated therewith referred to below as a “mana.” The mana associated with the enhancers comes into play in an instance where a maximum “mana” has been set for a fantasy game, thereby requiring the user to judiciously and strategically assign his/her enhancers. For example, a game may have a mana limit of X, which means that the total mana of the individual enhancers a user assigns may not exceed X. Thus, if a user assigns an enhancer having a mana value of X−5, the total combined mana of the other enhancers the user may assign cannot exceed five (5) (i.e., (X−5)+5=X, which is the maximum allowable mana). As such, a user may have to be economical, efficient, and strategic in how s/he manages the mana limit by, for instance, determining whether s/he is better off using multiple enhancers having a combined mana attributed thereto that is lower than that attributed to a single enhancer that, based on the match up, may be more likely to produce better results.

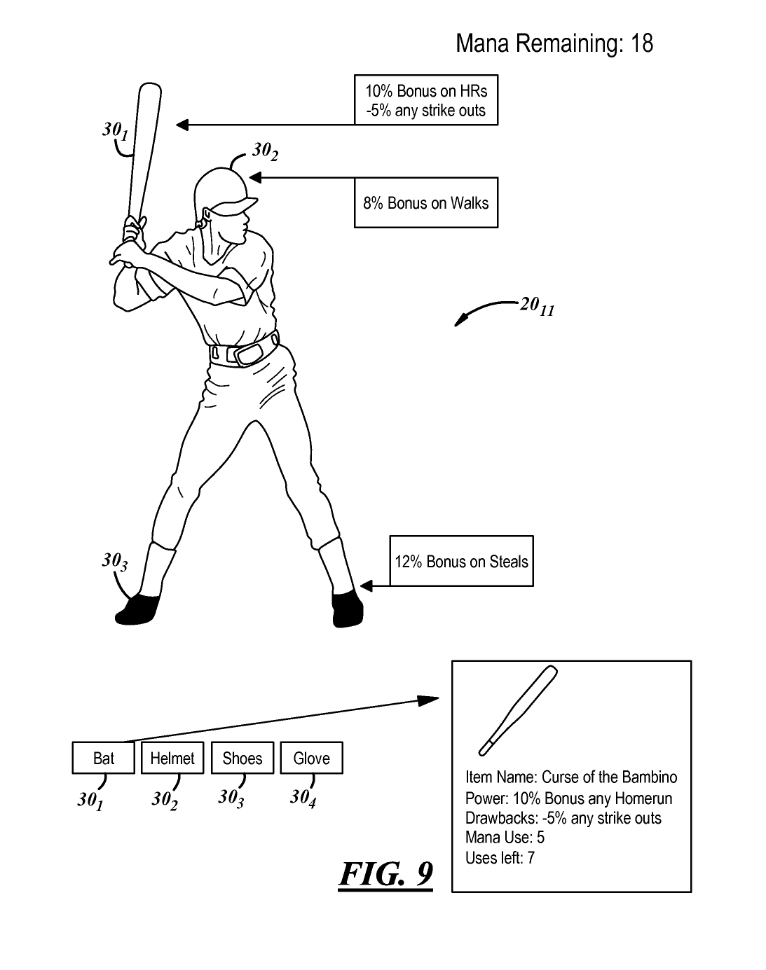

In any instance, when an enhancer is assigned to or associated with a team member in step 114, an indication may be provided for the user and, in certain instances, the other user's participating in the game, to see that reflects the assignment of the enhancer. For example, if a team member has been assigned an enhancer, an icon may be displayed proximate that member's name, the member's name may be displayed in a manner that distinguishes it from the other members of the fantasy team or on or in the roster or lineup that do not have enhances associated therewith (e.g., in a different color, font, and/or style), etc. In addition, or alternatively, when a team member's name is selected (e.g., clicked on), a graphical representation of the team member may be displayed. Along with the graphical representation of the team member, all of the enhancers that may be available to be assigned or associated with that particular team member, and/or the enhancers that have actually been assigned or associated with that team member may also be displayed. For purposes of illustration, FIG. 9 depicts an illustrative example a user interface 20₁₁ containing a graphical representation of a team member in the nature of a baseball player for which a number of different enhancers 34 are available to be assigned (e.g., a bat 34₁, a helmet 34₂, shoes 34₃, and a glove 34₄), and for which three (3) of such enhancers (i.e., enhancers 34₁-34₃) have been assigned to the team member. The first enhancer is the bat 34₁ that provides a point bonus (e.g., 10%) for home runs and a point penalty (−5%) for strike outs. The second enhancer is the helmet 34₂ that provides a point bonus (e.g., 8%) for walks. The third enhancer is the shoes 34₃ that provides a point bonus (e.g., 12% for stolen bases). Accordingly, in an embodiment, representations of equipment used in the sport to which the game corresponds may be utilized to indicate enhancers assigned to or associated with a team member. In view of the foregoing, it will therefore be appreciated that the enhancers assigned to team members on a given roster or in a lineup may be displayed in any number of ways, and thus, the present disclosure is not limited to any particular way(s).

With continued reference to FIG. 9, an illustrative example will now be provided to better describe how the feature of assigning enhancers works in practice. For purposes of this example, assume that a user has assigned the bat, helmet, and shoes described above to a given player. If the team member associated with those enhancers hits three (3) home runs in a game, and each home run is normally worth four (4) points, the team member will receive the normal twelve (12) points for the home runs plus a 10% bonus (because of the bat enhancer) for a total of 13.2 points. If, however, the team member strikes out three (3) times, and each strike out is worth (−3) points, the team member will have the normal −9 points plus a penalty of −5% (because of the bat enhancer) for a deduction of −9.45 points.

Accordingly, as can be seen in the above example, the enhancers may prove beneficial or detrimental to a user and will require a user to carefully determine the team members to which s/he assigns enhancers. For example, if a user's roster or lineup includes a team member that has had success as a batter against the pitcher he will face in his game, the user may want to assign one or more enhancers to that team member; whereas if the team member has had little success, the user may decide not to use an enhancer. Thus, selectively assigning enhancers to team members adds a layer of skill, interactively, flexibility, and/or options to the fantasy game by requiring a user to judiciously and strategically assign his/her enhancers.

The enhancers available to a user may be standard enhancers that are available to all users for free (e.g., each user may automatically receive a certain number and type of enhancers), and/or may be a premium feature of the game that are available for purchase using real or virtual currency, or that are earned based on past performance. Additionally, in certain instances, a user may be able to trade enhancer with other users.

In an embodiment, the central server 14 of the system 10 is configured to generate the user interface(s) that allow for the assignment of enhancers in step 114 and to communicate the interface(s) to the user input device 12 using, for example, the communication network 16. In another embodiment, however, some or all of the interface(s) may be generated by an app stored on the user input device 12 itself. In either instance, the interface(s) may be accessed from, for example, the lobby area discussed above, or from a link, icon, or portal displayed on another interface generated by the system 10 (e.g., the interface from which a user may select or designate team members for his lineup/roster, an interface that is generated when a particular team member is selected, etc.). In an embodiment, an enhancer may be assigned to team member by selecting (e.g., clicking on) the desired enhancer and, if applicable, indicating the team member with which the enhancer is to be associated (e.g., by clicking and dragging the enhancer to a team member). For example, in the illustrated embodiment depicted in FIG. 9, the available enhancers 34 may be presented in the form of user-selectable icons that a user may select from. In certain instances, and as illustrated in FIG. 9, a user may learn more about the enhancer before making a selection. For example, by hovering a cursor over an enhancer, information may be displayed, including, for example and without limitation, the name of the enhancer, the bonus/penalties associated therewith, the corresponding mana value, the number of remaining uses, etc.

In an instance wherein the user assigns one or more enhancers to one or more team members via a user interface generated in step 114, the user's selections or inputs may be be communicated to the central server 14 in the form of one or more electrical signals, and the central server 14 may be configured to process and act upon the inputs accordingly. For example, in some implementations, the central server 14 may receive the electrical signal(s), determine therefrom which enhancer(s) was/were selected/assigned, acquire the particular enhancements associated with the assigned enhancer(s) from, for example, a data structure (e.g., look-up table) stored in a memory device that is part of or accessible by the central server 14, and then apply those enhancements as described elsewhere herein. In other implementations. Alternatively, some or all of the inputs may be processed and acted upon locally at the user input device 12, and/or the inputs may be stored locally on the user input device 12 through an app stored thereon and communicated to the central server 14 at a later time.

Once a user has set his team/lineup (step 112) and, if applicable, has assigned enhancers to one or more team members (step 114), method 100 may include a step (not shown) of submitting the lineup by, for example, the user clicking or otherwise selecting a “SUBMIT” button on an suitably configured user interface. Alternatively, the lineup may be automatically submitted without the user taking any affirmative action. In an embodiment, the lineup may be communicated from the user input device 12 to the central server 14 in the form of one or more electrical signals representative of the lineup, and the central server 14 may be configured to associate the lineup with the user and store it in, for example, the memory 28 thereof. The lineup may thereafter be utilized by the processor 26 as described below. Alternatively, the lineup may be associated with the user and stored locally at the user input device 12 through an app stored thereon, and/or communicated to the central server 14 at a later time.

Following the submission of the user's lineup or roster, and regardless of whether the fantasy game being played or participated in is of the “traditional” or “enhanced” type, method 100 may comprise a step 116 of acquiring or accumulating certain information or data relating to one or more members of one or more of the fantasy teams (or user(s)) participating in the game as the team members play their respective “real” games. For each team member for which information or data is acquired (i.e., for each team member in the lineup or on the roster), this information and data may comprise, for example, respective game or competition statistics that are based on the performance of that team member in his/her real or actual game or competition, physical attributes of the team member, and any other information or data that may be used. The information or data may be acquired by, for example, the central server 14 itself, another component of the system 10, and/or from an external source, for example, a third party information source 32 (best shown in FIG. 1) (e.g., a statistics tracking service in the instance where game/competition statistics are utilized). This information may be received, for example, in the form of one or more electrical or electronic signals representative of the information or data.

In an embodiment, the central server 14 is configured to translate or convert the information/data corresponding to each team member into fantasy sports points (positive and negative) in accordance with a predetermined scoring scheme programmed into, for example, a memory device that is part of or accessibly by the central server 14, and the processor 26 thereof, in particular. For example, in the context of basketball, every point a team member scores in his/her game, every rebound a team member gets, and every assist a team member makes may equate to a certain number of fantasy points (e.g., one (1) fantasy point). Similarly, every blocked shot and every steal a team member makes may equate to a different number of fantasy points (e.g., two (2) fantasy points). Finally, every turnover a team member commits may equate to still another different number of fantasy points (e.g., negative one (−1) fantasy point). Similar scoring schemes may apply to other sports that lend themselves to fantasy sports games.

After all of the relevant team member's on a fantasy team have completed their games or competitions (i.e., all of the team members that are on the roster or in the lineup for the fantasy game being played or participated in), the points generated by the information/data corresponding to each team member (e.g., game/competition statistics) and any enhancers assigned thereto (if applicable) are tallied together in a step 118 of method 100 to come to a point total for that fantasy team (i.e., user). The user's point total may then be compared to that of the other users participating in the fantasy game and in a step 120 of method 100, a winner may be declared. If applicable, prizes may be awarded to the winner, and in certain instances, other users based on the place in which each user finished. The prizes may include, for example, real or virtual currency prizes (e.g., adding a certain predetermined amount of money to a user's account, adding a certain number of points to the user's account), virtual items that may be added to the user's avatar or custom character, additional enhancers that the user may use or assign to a team member in the next fantasy game, gift cards, and/or any other suitable prize.

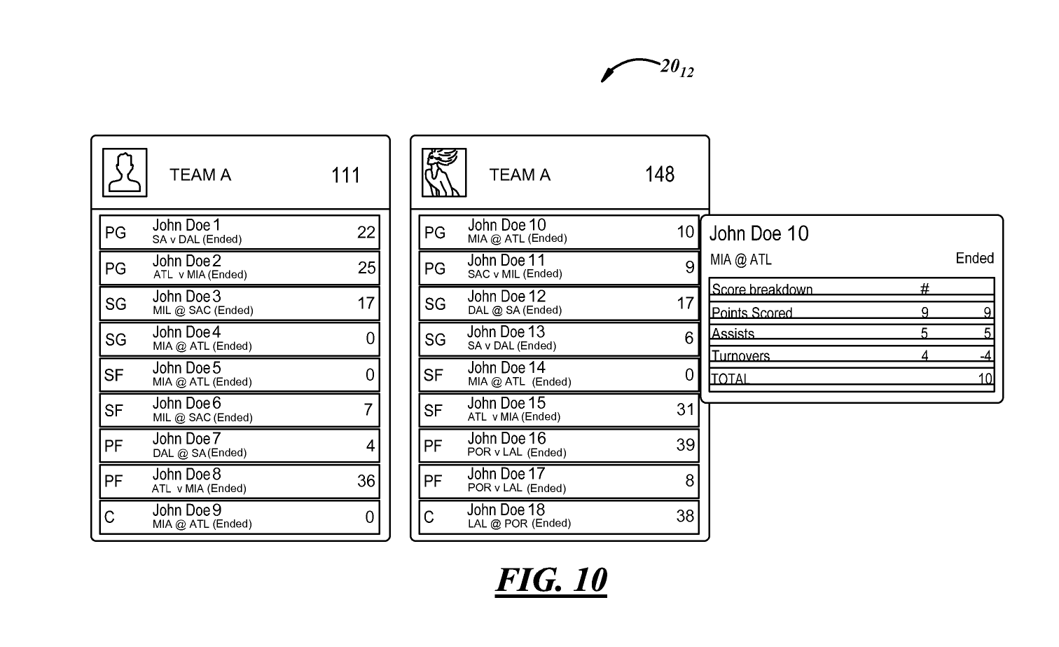

In an embodiment, the fantasy game may be configured, the users participating in the game may agree, or a user may unilaterally decide to allow for the “playing out” or progress of the game to be viewed in a number of ways. In one embodiment, the points generated by each member of each fantasy team may be viewed in real time as the game progresses. Accordingly, in such an embodiment, method 100 may comprise a step of displaying scoring information by generating or updating a user interface that may be displayed on or be accessible by the user input devices 12 of the users participating in the game or otherwise on another display device (e.g., computer monitor, television, hand-held device, etc.) that keeps a running total of the points generated by the individual team members and an overall total for each team. The point total for a given individual member of a team may be drilled down to show the information corresponding to that team member (e.g., statistics) that resulted in the point total. An example of this type of display and interface is illustrated as user interface 20₁₂ in FIG. 10. As with some of the other interfaces described above, in an embodiment, this interface may be generated by the central server 14, for example, and may be communicated to the user input devices 12 over the communication network 16.

In another embodiment, rather than showing the point totals for the individual members of fantasy teams and the overall team point total in real time, the scoring information may only be available for viewing once the fantasy game has ended (i.e., once all of the team members of each fantasy team have completed their respective games). Accordingly, in such an embodiment, method 100 may comprise a step of displaying scoring information by generating or updating a user interface containing final point totals of each member of each team and/or final overall point totals for each team that may be displayed on or be accessible by the user input devices 12 of the users participating in the game or otherwise on a display device following the conclusion of the fantasy game. As with the embodiment described above, the point total for a given individual team member may be drilled down to show the information corresponding to that team member that resulted in the point total. The interface 20₁₂ depicted in FIG. 10 is also an example of an interface that may be used in this embodiment. As with some of the other interfaces described above, in an embodiment, this interface may be generated by the central server 14, for example, and may be communicated to the user input devices 12 over the communication network 16.

In yet another embodiment, the fantasy game may be recreated or reenacted in an audio (e.g., sound bites), visual (e.g., video clips, animation, and/or other graphical or visual content), or audio/visual program (referred to herein as a “play-out” or “playback” program) that may be generated and displayed for the users participating in the game or otherwise to view and see how the fantasy game played out (if the game is completed) or how the game is progressing (if the game has not yet concluded).

More particularly, in an embodiment, method 100 may comprise a step 122 of generating a program (also referred to as a “playback program”) that reenacts how the game unfolded and, if appropriate, how the game ended. Such a program may be generated using one or more types of information. This information may include one or a combination of: information relating to one or more of the individual members of one or more of the fantasy teams participating in the fantasy game (e.g., statistics for one or more team members from the actual games they are participating in or have participated in, the occurrence of events relating to one or more team members (e.g., home runs, touchdowns, etc.), fantasy points attributed to one or more team members, etc.); an overall point total (or a score derived therefrom) for one or more fantasy teams taking part in the fantasy game; and/or other suitable and useful information. More specifically, in some implementations, step 122 may comprise using one or more types of information identified above to select one or more portions of audio, visual, or audio/visual content that may then be used to generate the playback program that corresponds to a particular fantasy game. In an embodiment, this may comprise selecting one or more portions of content stored in a database (e.g., data structure 30) on a memory device (e.g., memory device 28 of central server 14), and then using the selected content to generate a playback program that may be viewed by the users. In other words, the selected content may be combined together using known techniques to generate a composite playback program.

In an illustrative embodiment, the content selected for the program generated in step 122 may be selected based in whole or in part on the occurrence of events relating to members of the fantasy teams participating in the fantasy game. For example, when one of a predetermined number of specific events occurs with respect to a member of one of the fantasy teams participating in the fantasy game, content relating to that event may be selected and ultimately incorporated into the playback program. For instance, in the context of a fantasy baseball game, if a home run is hit, an audio, visual, or audio/visual clip may be selected that corresponds to a home run (e.g., a video or animation of a home run being hit, a play-by-play call of a home run, etc.). This may include a clip of a home run alone, or a clip of a sequence of events that culminates in a home run (for example, if a two-run home run is hit, the clip may include a player getting on base (walk, base hit, etc.) followed by a home run). Similarly, in the context of a fantasy football game, if a touchdown is scored, a clip may be selected that corresponds to a touchdown or touchdown along with events leading up to and culminating in the touchdown or events/plays following the touchdown (e.g., extra point). In any event, in an embodiment, the selected content may be directly related and correspond to the occurrence of certain events relating to the particular type of fantasy game being conducted.

In one embodiment, the content may be selected randomly from the stored content relating to or associated with the event that occurred. For example, if the event is a home run, an audio/visual clip of a home run being hit may be selected randomly from a plurality of clips stored in the database that correspond to home runs. Alternatively, the content may be selected taking into account one or more predetermined factors or considerations. Such factors may include, for example, the identity of the team member that the event relates to and/or the actual team the team member plays for (such that the selected content may relate specially to a particular player or team—e.g., the clip of a home run may be a clip of that particular player hitting a home run), user preferences associated with the fantasy team (e.g., selecting only certain types of content (e.g., only video clips, not animation), and any other suitable factor(s)/consideration(s).

In another illustrative embodiment, the content selected for the program generated in step 122 may be additionally or alternatively selected based in whole or in part, and directly or indirectly, on each team's overall point total during and/or at the conclusion of the fantasy game, depending on whether the playback program corresponds to a fantasy game that is in progress or that has been completed. This may be done in a number of ways. In one embodiment, a team's overall point total is converted into a score for that team, and that score may be used to select the content for the playback program. The converted scores may represent more realistic scores that may be attained during the playing of an actual game of the sport or contest that the fantasy game corresponds to. For example, in a fantasy baseball game, the overall point totals of one or more of the participating fantasy teams may be converted into runs, and the overall point totals may be scaled down to smaller numbers (e.g., from points in the tens to scores in the ones). Similarly, in a fantasy football game, the overall point total(s) may be converted into football points, and the overall point total(s) may be scaled down to (a) smaller number(s) (e.g., from points in the hundreds to points in the ones or tens). The point conversion may be carried out in a number of ways. In one illustrative embodiment, a scaling factor may be applied to the overall point total(s) (e.g., the overall point total(s) may be divided by a particular and suitable scaling factor, which, in a particular implementation, may be a factor of 10).

Whether or not the fantasy point total for a team is scaled, in an embodiment, content is selected that when combined together results in the playback program showing a scenario of how the overall points or scaled/converted score(s) was/were achieved. For instance, if a team in a fantasy football game has a scaled or converted score of 17, content corresponding to, for example, two touchdowns (6 points each), two extra points (1 point each), and a field goal (3 points) may be selected to come to a total of 17 points. Similarly, in the context of fantasy baseball, if a team has three (3) runs, content corresponding to the scoring of three runs (e.g., two singles and a home run; a combination of base hits that produce three runs; etc.) may be selected to come to a total of three runs. In either of the above instances, the content may be integrated into single content portion or clip, or alternatively, multiple content portions may be combined together.

As with the embodiment described above wherein content is selected based on the occurrence of certain events, in one embodiment, the content selected based on points or scores may be selected randomly. For example, if content relating to a touchdown is needed, an audio/visual clip of a touchdown may be selected randomly from a plurality of clips stored in the database that correspond to touchdowns. Alternatively, the content may be selected taking into account one or more predetermined factors or considerations including, but certainly not limited to, the identity of one or more team members of the fantasy team and/or the actual team(s) the team member(s) play(s) for (such that the selected content may relate specially to a particular player or team—e.g., the clip of a touchdown may be a clip of a team member scoring a touchdown), user preferences associated with the fantasy team (e.g., selecting only certain types of content (e.g., only video clips, not animation)), and/or any other suitable factor(s)/consideration(s).

For purposes of illustration only, a description of an illustrative playback program that is based indirectly on the overall point totals of two fantasy baseball teams (users)—one having a point total of 60 points, the other having a point total of 48 points—will now be described. In this example, each user's point total is first converted into a score for that user's team. For instance, each user's point total may be divided by a particular scaling factor (e.g., ten (10)) to convert the point total into a number of runs. Accordingly, when a scaling factor of 10 is applied, the first user will have six (6) runs and the second user will have five (5) (rounded up from 4.8). Whether or not the game is still ongoing, and for these particular scores, the processor 26 may be configured to use one or more algorithms to process or interpret the converted scores and to then select audio, visual, and/or audio/visual content that will illustrate or depict a scenario for attaining each respective score. For example, the fantasy game may be played back or played-out as described below.

First, the first user is up to bat and the generated program may display (audibly, visually, or both) the following selected content forming a sequence of plays/at-bats that serve to generate that user's point total (six (6) runs): the first batter hits a single; the second batter walks; the third batter hits a double scoring one (1) run (current run total=1); the fourth batter draws a walk; the fifth batter hits a home run scoring three (3) runs (current run total=4); the sixth and seventh batters strike out and fly out, respectively; the eighth batter hits a triple scoring one (1) run (current run total=5); the ninth batter hits a single scoring one (1) run (current run total=6); and the tenth batter grounds out ending the first user's scoring. Next, the second user is up to bat and the generated program may similarly display the following selected content forming a sequence of plays/at-bats that serve to generate that user's point total (five (5) runs): the first batter strikes out; the second and third batters each hit singles; the fourth batter hits a double scoring two (2) runs (current run total=2); the fifth batter strikes out; the sixth and seventh batters walk; the eighth batter hits a home run scoring three (3) runs (current run total=5); and the ninth batter lines out ending the second user's scoring. In an instance wherein the fantasy game is still in progress, the users may be advised as such; in the instance where the game is over, a winner is declared. In the event that the game is over and there is a tie (e.g., first user has 88 points or 9 runs and the second user has 87 points or 9 runs), in an embodiment, the user with the most raw points would be awarded an extra run to break the tie. Accordingly, in the example above where each user has nine (9) runs, the first user would be given an additional run so that he would be declared the winner since s/he had more fantasy points (i.e., 88 to 87).

For each user's turn, the plays set forth above may be associated with one or more audio, visual, or audio/visual clip(s) of the corresponding play (e.g., video clips of past plays by a particular real-world player, famous players, etc.), animated clip(s), audio clip(s) with a “call” of the play (e.g., past calls by famous announcers), and/or other graphical, visual, or audio content. If appropriate, the content for each play may then be combined with the content associated with the other plays to form a program that may be displayed to the users.

It will be appreciated by those having ordinary skill in the art in view of the foregoing that the particular content selected may be done so in any number of ways and/or using any number of techniques (e.g., random vs. structured, occurrences of events vs. point totals/scores, etc), and therefore, the present disclosure is not limited to any particular means of or techniques for doing so.

Further, in an embodiment, the respective point totals for each user or team participating may be displayed as the program progresses, or alternatively, the point total may not be displayed until the end of the program. In any event, rather than simply watching the point totals of each user, or seeing a grand total at the end of fantasy game, the play-out or playback feature described above adds an extra level of excitement and enjoyment to the fantasy game. Additionally, while in the examples provided above the playback program included content corresponding to multiple fantasy teams participating in a fantasy game, in some implementations the playback program may include content relating only to a single fantasy team and may not include content relating to other fantasy teams participating in the fantasy game (e.g., in an instance wherein a user only wants to see a playback of his/her team, not the others participating in the fantasy game).

In an embodiment, step 122 may be performed by the processor 26 of the central server 14, and an algorithm and/or information (e.g., software) accessible thereby, in particular, which may process or interpret the acquired information, discern what content is required (e.g., clip(s) of touchdown, field goal, extra point; or solo home run, grand slam, etc. using information received in, for example, step 116) and select and acquire or obtain the content for the program from either the memory device 28 of the central server 14, from another memory device of the system 10, or from an external memory device or information source, for example, a third party information source 32 (e.g., content server). Alternatively, a component of the system 10 other than the central server 14, or a component that is not part of the system 10 (e.g., content server) may be configured to perform this step.

In some implementations, once the generation of the playback program has been completed, one or more electronic signals may be generated that is/are representative of the program, and that or those signal(s) may then be electronically communicated to, for example, the user input devices of the users participating in the game or to another display device (e.g., television, computer monitor, hand-held device) such as that or those described elsewhere herein, either automatically or upon a user request to do so, and then may be displayed.

In any of the embodiments described above, the particular means or manner by which the game may be played out or viewed may be in response to an agreement between the users participating in the game, may be in response to one user's input, or may be a default setting. In an instance where a user's input is taken into consideration, each user participating in the game may be prompted to select a desired display means/manner. This selection may be communicated from the user input device 16 to the central server 14, for example, where it may be processed and acted on accordingly. In such an embodiment, the user may be prompted to select the particular display means/manner during any one or more of the steps described above (e.g., when selecting a game, choosing players, etc.), or at any other time, e.g., prior to the fantasy game commencing.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Further, the term “electrically connected” and the variations thereof is intended to encompass both wireless electrical connections and electrical connections made via one or more wires, cables, or conductors (wired connections). Other terms are to be construed using their broadest reasonable meaning unless they are used in a context that requires a different interpretation.

1. A method of conducting a fantasy event, comprising:
acquiring information relating to one or more members of one or more fantasy teams participating in the fantasy event;
automatically selecting one or more portions of audio, visual, and/or audio/visual content stored in an electronic memory device using the acquired information, wherein the selected content may be used to reenact at least a portion of the fantasy event; and
generating a playback program using the selected content that reenacts at least a portion of the fantasy event.

2. The method of claim 1, further comprising:
for at least one of the one or more members of at least one of the one or more fantasy teams, translating the acquired information into a fantasy point total in accordance with a predetermined scoring scheme;
for each of the at least one of the one or more fantasy teams, determining an overall fantasy point total based on the fantasy point totals of the at least one of the one or more members of that fantasy team; and
selecting the one or more portions of the content based on the overall fantasy point totals of each of the at least one of the one or more fantasy teams.

3. The method of claim 2, further comprising converting the overall fantasy point totals of each of the at least one of the one or more fantasy teams into respective scores for each fantasy team, and wherein the selecting step comprises selecting the one or more portions of content based on the converted scores of each of the at least one of the one or more fantasy teams.

4. The method of claim 2, wherein the selecting step comprises selecting the one or more portions of content based on the overall point totals of each of the at least one of the one or more fantasy teams.

5. The method of claim 1, wherein the acquired information relates to an occurrence of one or more events relating to the one or more team members, and the selecting step comprises selecting the one or more portions of content based on the occurrence of the one or more events.

6. The method of claim 1, further comprising causing the playback program to be displayed on a display device.

7. The method of claim 1, further comprising:
generating one or more electronic signals representative of the generated playback program; and
communicating the electronic signal(s) to one or more user input devices.

8. The method of claim 1, wherein prior to performing the generating step the method further comprises determining that the fantasy event has been completed, and further wherein the generating step is performed only in response to a determination that the fantasy event has been completed.

9. A system for conducting a fantasy event, comprising:
an electronic processor; and
an electronic memory device electrically coupled to the electronic processor and having instructions stored therein,
wherein the processor is configured to access the memory device and execute the instructions stored therein such that it is operable to:
acquire information relating to one or more members of one or more fantasy team participating in the fantasy event;
automatically select one or more portions of audio, visual, and/or audio/visual content stored in an electronic memory device using the acquired information, wherein the selected content; and
generate a playback program using the selected content that reenacts at least a portion of the fantasy event.

10. The system of claim 9, wherein the processor is operable to:
for at least one of the one or more members of at least one of the one or more fantasy teams, translate the acquired information into a fantasy point total in accordance with a predetermined scoring scheme;
for each of the at least one of the one or more fantasy teams, determine an overall fantasy point total based on the fantasy point totals of the at least one of the one or more members of that fantasy team; and
select the one or more portions of the content based on the overall fantasy point totals of each of the at least one of the one or more fantasy teams.

11. The system of claim 10, wherein the processor is operable to convert the overall fantasy point totals of each of the at least one of the one or more fantasy teams into a respective scores for each fantasy team, and to select the one or more portions of content based on the converted scores of each of the at least one of the one or more fantasy teams.

12. The system of claim 10, wherein the processor is operable to select the one or more portions of content based on the overall point totals of each of the at least one of the one or more fantasy teams.

13. The system of claim 9, wherein the acquired information relates to an occurrence of one or more events relating to the one or more team members, and further wherein the processor is operable to select the one or more portions of content based on the occurrence of the one or more events.

14. The system of claim 9, further comprising a display device, wherein the processor is operable to cause the playback program to be displayed using the display device.

15. The system of claim 9, wherein the acquired information comprises game or competition performance statistics.

16. The system of claim 9, wherein the processor is operable to generate one or more electronic signals representative of the generated playback program, and to communicate the electronic signal(s) to one or more user input devices.

17. A method of conducting a fantasy event, comprising:
assigning a point enhancer to a particular member of a fantasy team in response to a user input, wherein the enhancer serves to enhance the fantasy point total of that particular team member;
acquiring information corresponding to the particular team member to which the enhancer was assigned; and
determining, based on the acquired information and on the assigned enhancer, a fantasy point total for the particular team member to which the enhancer was assigned in accordance with a predetermined scoring scheme.

18. The method of claim 17, wherein the point enhancement corresponding to the assigned enhancer comprises a positive point enhancement, a negative point enhancement, or both.

19. The method of claim 17, wherein the enhancer results in one or both of fantasy points being added to the team member's fantasy point total in response to the occurrence of a predetermined event, and fantasy points being deducted from the team member's fantasy point total in response to the occurrence of a different predetermined event.

20. The method of claim 17, further comprising generating a user interface from which a user may select an enhancer to be assigned to a member of a fantasy team.

21. The method of claim 20, wherein the user interface includes a display of the available enhancers from which a user may make a selection, and information relating to those available enhancers.

22. The method of claim 17, further comprising generating a user interface that reflects the assignment of the enhancer to the particular team member to which it was assigned.

23. The method of claim 17, further comprising:
receiving one or more electrical signals representative of a selected enhancer, the enhancer having a predetermined value associated therewith;
determining whether the assignment of the selected enhancer will result in the total value of assigned enhancers exceeding a predetermined maximum value set for the fantasy event; and
assigning the enhancer to the particular team member only if the predetermined maximum value will not be exceeded as a result of the assignment of the selected enhancer.

24. A system for conducting a fantasy event, comprising:
an electronic processor; and
an electronic memory device electrically coupled to the electronic processor and having instructions stored therein,
wherein the processor is configured to access the memory device and execute the instructions stored therein such that it is operable to:
assign a point enhancer to a particular member of a fantasy team in response to a user input, wherein the enhancer serves to enhance the fantasy point total of that particular team member;
acquire information corresponding to the particular team member to which the enhancer was assigned; and
determine, based on the acquired information and on the assignment enhancer, a fantasy point total for the particular team member to which the enhancer was assigned in accordance with a predetermined scoring scheme.

25. The system of claim 24, wherein the point enhancement corresponding to the assigned enhancer comprises a positive point enhancement, a negative point enhancement, or both.

26. The system of claim 24, wherein the enhancer results in one or both of fantasy points being added to the team member's fantasy point total in response to the occurrence of a predetermined event, and fantasy points being deducted from the team member's fantasy point total in response to the occurrence of a different predetermined event.

27. The system of claim 24, wherein the processor is further operable to generate a user interface from which a user may select an enhancer to be assigned to a member of a fantasy team.

28. The system of claim 27, wherein the user interface includes a display of the available enhancers from which a user may make a selection, and information relating to the available enhancers.

29. The system of claim 24, wherein the processor is further operable to generate a user interface that reflects the assignment of the enhancer to the particular team member to which it was assigned.

30. The system of claim 24, wherein the processor is further operable to:
receive one or more electrical signals representative of a selected enhancer, the enhancer having a predetermined value associated therewith;
determine whether the assignment of the selected enhancer will result in the total value of assigned enhancers exceeding a predetermined maximum value set for the fantasy event; and
assign the enhancer to the particular team member only if the predetermined maximum value will not be exceeded as a result of the assignment of the selected enhancer.
